(19) United States
(12) Patent Application Publication
(10) Pub. No.: US 2015/0363392 A1
(43) Pub. Date: Dec. 17, 2015

(54) REAL-TIME MODIFICATION OF INPUT METHOD BASED ON LANGUAGE CONTEXT

(71) Applicant: Lenovo (Singapore) Pte. Ltd., Singapore (SG)

(72) Inventors: Nathan J. Peterson, Durham, NC (US); Jennifer Lee-Baron, Morrisville, NC (US); Amy Leigh Rose, Chapel Hill, NC (US); John Scott Crowe, Durham, NC (US)

(21) Appl. No.: 14/301,964

(22) Filed: Jun. 11, 2014

(51) Int. Cl. G06F 17/28; G06F 3/023

(52) U.S. Cl. CPC G06F 17/289; G06F 3/0233

(57) ABSTRACT

An aspect provides a method, including: implementing, using a processor, a current language setting for an input component of an electronic device; detecting, using a processor, a language context using data accessible to the electronic device; determining, using a processor, if the language context is mismatched with the current language setting; and responsive to the determining, automatically switching, using a processor, the current language setting to a language setting matching the language context detected. Other aspects are described and claimed.

### BACKGROUND

Information handling devices (“devices”), for example cell phones, smart phones, tablet devices and the like, have communication capabilities, including messaging application functionality. Users input text (whether via key inputs or other modes, e.g., handwriting inputs converted to text, voice inputs converted to text, etc.) into a communication or like application using an input component, e.g., a soft keyboard, a mechanical keyboard, a microphone and speech to text processing module, etc.

When inputting words or phrases, irrespective of the application, the device interprets these user inputs in a given language indicated by a current language setting. For example, in North America, the language setting may by default be set to English. There are times when a user wants or needs to provide inputs using a different language. In order to fully accomplish this task, often the current language setting (e.g., keyboard setting) will need to be changed. This provides the user with access to alternative keys that may not be available in the current language. A common example is a bilingual user that needs to switch between English and Spanish. Another common example is a user employing a language learning application, where the user needs to switch between providing inputs in more than one language repeatedly. Language settings may be altered by the user via manual inputs to open a settings menu and choose the desired language setting. After the user has manually set the language setting to the appropriate language, a user may thereafter provide inputs that are received in the new language.

### BRIEF SUMMARY

In summary, one aspect provides a method, comprising: implementing, using a processor, a current language setting for an input component of an electronic device; detecting, using a processor, a language context using data accessible to the electronic device; determining, using a processor, if the language context is mismatched with the current language setting; and responsive to the determining, automatically switching, using a processor, the current language setting to a language setting matching the language context detected.

Another aspect provides a device, comprising: a display device; an input component; a processor operatively coupled to the display device and the input component; and a memory operatively coupled to the processor that stores instructions executable by the processor, the instructions comprising: implement a current language setting the input component; detect a language context using data accessible to the device; determine if the language context is mismatched with the current language setting; and responsive to determining a mismatch between the current language setting and the language context, automatically switch the current language setting to a language setting matching the language context detected.

A further aspect provides a program product, comprising: a storage device having program code embodied therewith, the program code being executable by a processor and comprising: program code that implements a current language setting for an input component of an electronic device; program code that detects a language context using data accessible to the electronic device; program code that determines if the language context is mismatched with the current language setting; and program code that, responsive to the determining, automatically switches the current language setting to a language setting matching the language context detected.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device.

FIG. 2 illustrates another example information handling device.

FIG. 3 illustrates an example method of modification of input method based on language context.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In certain contexts, e.g., for multi-lingual device users, users are required to manually change their keyboard language by going through a manual settings change process. This is burdensome if the user is going back and forth between sending a message to a user of one language, and then sending other messages to a user of a second language. Currently users are forced into a manual selection process to switch the language setting for the input component, e.g., soft keyboard.

Accordingly, an embodiment provides a method for real-time modification of input method based on language context, e.g., as determined from typed text input or previous history. An embodiment, for a current language setting for an input component of an electronic device, detects a language context using data accessible to the electronic device and determines if the language context is mismatched with the current language setting. If so, an embodiment automatically switches the current language setting to a language setting matching the language context detected.

By way of non-limiting example, as the user is typing characters into the input component (e.g., keyboard), an embodiment identifies the language that is being typed as the user input is provided (i.e., in real-time) and modifies the language setting of the keyboard. If a user has already typed most of the word or phrase in a first language, e.g., without special accents, etc., an embodiment may use an autocorrect like method to make (or suggest) changes for the previous input.

As another non-limiting example, if a user generally types in a specific language to certain friends or family members, e.g., stored in device contacts (whether on device on stored elsewhere), an embodiment may automatically change to the appropriate language based on a prior messages history regarding that user or contact, rather than (or in addition to) what is being typed.

The illustrated example embodiments will be best understood by reference to the figures. The following description is intended only by way of example, and simply illustrates certain example embodiments.

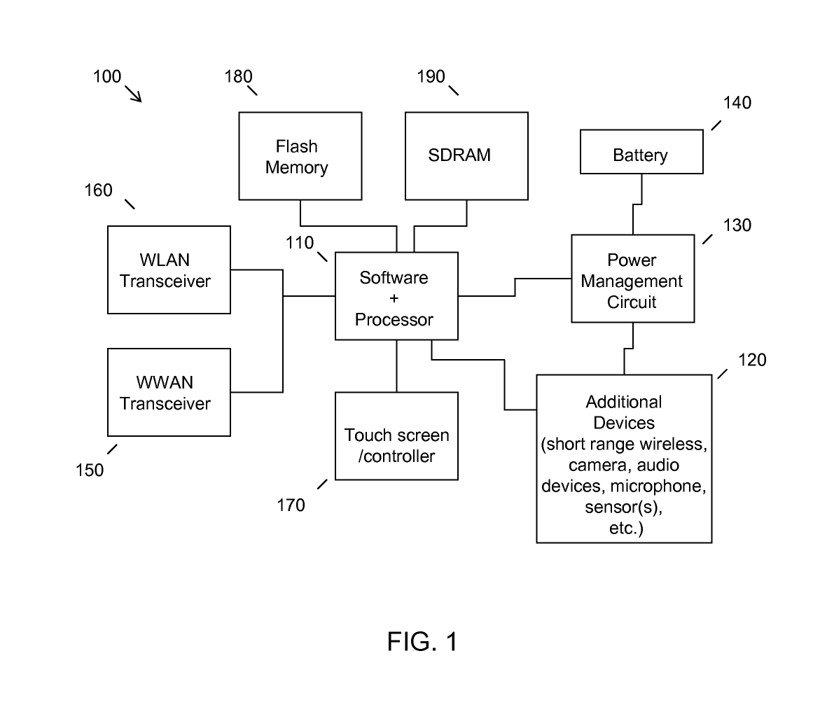

While various other circuits, circuitry or components may be utilized in information handling devices, with regard to smart phone and/or tablet circuitry 100, an example illustrated in FIG. 1 includes a system design found for example in tablet or other mobile computing platforms. Software and processor(s) are combined in a single unit 110. Internal busses and the like depend on different vendors, but essentially all the peripheral devices (120) may attach to a single unit 110. The circuitry 100 combines the processor, memory control, and I/O controller hub all into a single unit 110. Also, systems 100 of this type do not typically use SATA or PCI or LPC. Common interfaces for example include SDIO and I2C.

There are power management circuits(s) 130, e.g., a battery management unit, BMU, which manage power as supplied for example via a rechargeable battery 140, which may be recharged by a connection to a power source (not shown). In at least one design, a single unit, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included. Additional devices may include short range wireless radio(s), such as BLUETOOTH radios, for communicating with other devices. Near field communication element(s) may also be included as additional device(s) 120. Commonly, system 100 will include a touch screen/controller 170 for data input and display. System 100 also typically includes various memory devices, for example flash memory 180 and SDRAM 190.

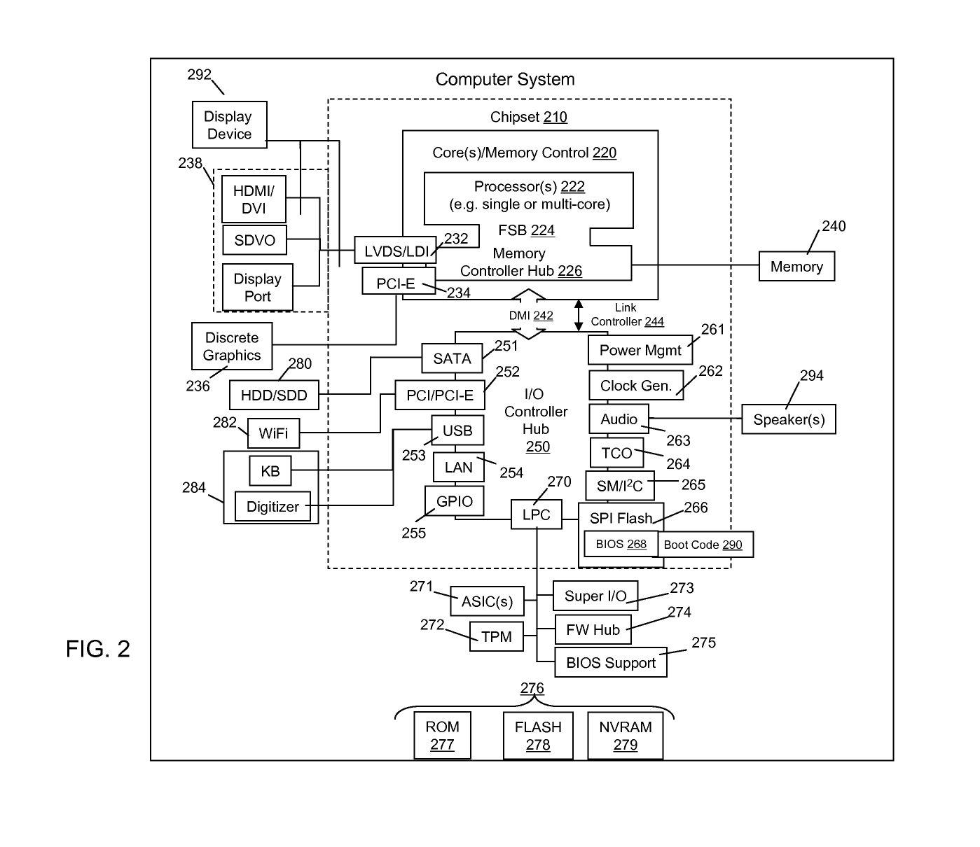

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a set 210 (a group of integrated circuits that work together) with an architecture that may vary depending on manufacturer (for example, INTEL, AMD, ARM, etc.). INTEL is a registered trademark of Intel Corporation in the United States and other jurisdictions. AMD is a registered trademark of Advanced Micro Devices, Inc. in the United States and other jurisdictions. ARM is a trademark of ARM Holdings plc in various jurisdictions.

The architecture of the set 210 includes a core and memory control group 220 and an I/O controller hub 250 that exchanges information (for example, data, signals, commands, etc.) via a direct management interface (DMI) 242 or a link controller 244. In FIG. 2, the DMI 242 is an interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a unit that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280, etc.), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones and/or other devices with which a user provides inputs to an input component using multiple languages. Device circuitry may include hardware and/or software for providing input components such as a soft keyboard with multiple language settings.

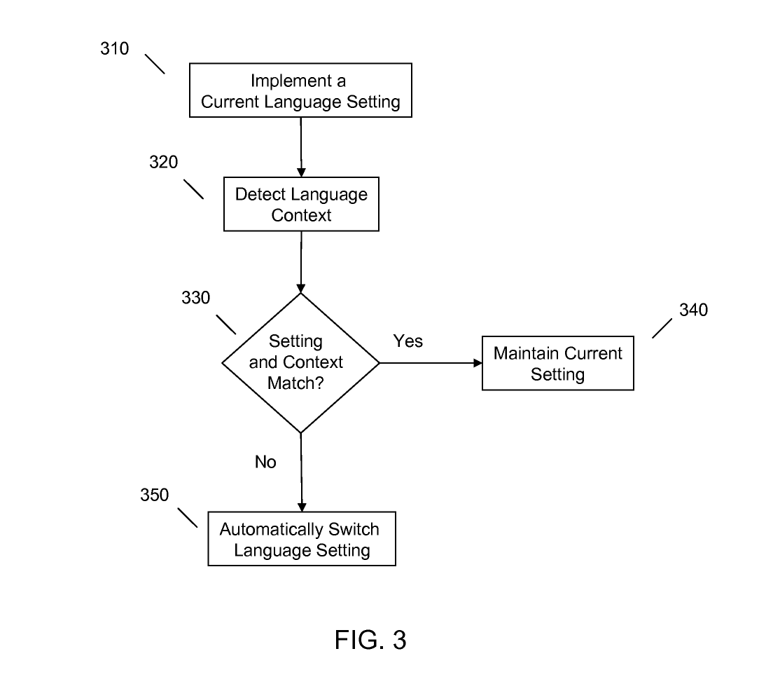

In an embodiment, and referring to FIG. 3, an embodiment will implement a current language setting at 310, e.g., English language, for an input component of an electronic device, e.g., soft keyboard of a tablet computing device. An embodiment may detect at 320, e.g., during a user providing input to the soft keyboard, a language context using data accessible to the electronic device.

The data used to detect a language context at 320 may include, but is not limited to, typed user input to the soft keyboard, a contact stored in the electronic device, e.g., to which a message being typed is directed, which may include a user history of a language setting used with the contact previously, and/or application data, e.g., a language setting indictor associated with a particular application or specified by a particular application.

Having the data from which to determine or infer a language context, an embodiment may then determine at 330 if the language context is mismatched with the current language setting for the input component. If not mismatched, an embodiment may maintain the current language setting for the input component at 340.

On the other hand, if there is a mismatch determined at 330, an embodiment may automatically switch the current language setting at 350 to a language setting matching the language context detected. For example, an English language setting may be switched at 350 to a Spanish language setting responsive to detecting at 320 that the user is inputting a message (e.g., SMS text message) to a user contact known (e.g., via user history) to prefer Spanish language messages.

As another example, an embodiment may automatically switch an English language setting to a German language setting at 350 responsive to detecting at 320 that the user is employing a language learning tool that is requesting German language input. Likewise, an embodiment may automatically switch an English language setting to a French language setting at 350 responsive to detecting at 320 that the user has typed the beginning of a word using English letters that matches or maps to a French language word. As described herein, an embodiment may convert previous user input provided to the input component to a new language after the automatic switching has occurred. The changed language setting may persist until another mismatch is detected at 330.

Additionally, an embodiment may solicit user feedback or confirmation prior to or after the automatic switching, e.g., to improve performance. For example, an embodiment may provide a notification to a user of the automatic switching, e.g., visual notification of a suggested switch, which may include the input converted to the new language as a preview. An embodiment may wait, e.g., a predetermined time, to receive a user input in response to the notification, for example prior to implementing the automatic switching (or not implementing the automatic switching). An embodiment may also adjust the automatic switching according to the user input, e.g., inputting only a single converted word or phrase, implementing a global language setting change, and/or reversing an automatic switching that took place prior to user confirmation or feedback.

Accordingly, an embodiment facilitates convenient switching between language settings (back and forth in real time) given the language context detected. The language context may be detected in a variety of ways, as described herein, and these methods of detecting language context may be combined. Once a mismatch has been determined, an embodiment may provide the user with a notification thereof, such that the user remains in control of the automatic switching. Learning over time may be implemented, e.g., storage and processing of prior language switching, such that an embodiment implements and/or suggests language switches that more closely match the user's desires.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
implementing, using a processor, a current language setting for an input component of an electronic device;
detecting, using a processor, a language context using data accessible to the electronic device;
determining, using a processor, if the language context is mismatched with the current language setting; and
responsive to the determining, automatically switching, using a processor, the current language setting to a language setting matching the language context detected.

2. The method of claim 1, wherein the data used to detect a language context comprises user input to the input component.

3. The method of claim 1, wherein the data used to detect a language context comprises a contact stored in the electronic device.

4. The method of claim 3, wherein the data used to detect a language context comprises a user history of language setting used with the contact.

5. The method of claim 1, wherein the data used to detect a language context comprises application data.

6. The method of claim 5, wherein the application data comprises a language setting indictor specified by the application.

7. The method of claim 1, wherein the automatic switching occurs after user input is received at the input component.

8. The method of claim 7, further comprising converting previous user input provided to the input component to a new language after the automatic switching.

9. The method of claim 1, further comprising providing a notification to a user of the automatic switching.

10. The method of claim 9, further comprising:
receiving a user input in response to the notification; and
adjusting the automatic switching according to the user input.

11. A device, comprising:
a display device;
an input component;
a processor operatively coupled to the display device and the input component; and
a memory operatively coupled to the processor that stores instructions executable by the processor, the instructions comprising:
implement a current language setting the input component;
detect a language context using data accessible to the device;
determine if the language context is mismatched with the current language setting; and
responsive to determining a mismatch between the current language setting and the language context, automatically switch the current language setting to a language setting matching the language context detected.

12. The device of claim 11, wherein the data used to detect a language context comprises user input to the input component.

13. The device of claim 11, wherein the data used to detect a language context comprises a contact stored in the device.

14. The device of claim 13, wherein the data used to detect a language context comprises a user history of language setting used with the contact.

15. The device of claim 11, wherein the data used to detect a language context comprises application data.

16. The device of claim 15, wherein the application data comprises a language setting indictor specified by the application.

17. The device of claim 11, wherein the automatic switch occurs after user input is received at the input component.

18. The device of claim 17, wherein the instructions are further executable by the processor to convert previous user input provided to the input component to a new language after the automatic switch.

19. The device of claim 11, wherein the instructions are further executable by the processor to provide a notification to a user of the automatic switching.

20. A program product, comprising:
a storage device having program code embodied therewith, the program code being executable by a processor and comprising:
program code that implements a current language setting for an input component of an electronic device;
program code that detects a language context using data accessible to the electronic device;
program code that determines if the language context is mismatched with the current language setting; and
program code that, responsive to the determining, automatically switches the current language setting to a language setting matching the language context detected.
